(19) United States
(12) Patent Application Publication
(10) Pub. No.: US 2009/0196154 A1
(43) Pub. Date: Aug. 6, 2009

(54) METHOD FOR MANUFACTURING A BEARING MECHANISM, ELECTRIC MOTOR AND STORAGE DISK DRIVE APPARATUS

(75) Inventor: Masato Gomyo, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 12/360,172

(22) Filed: Jan. 27, 2009

(30) Foreign Application Priority Data
Feb. 6, 2008 (JP) 2008-025958

(51) Int. Cl. G11B 23/00; B21D 53/10

(52) U.S. Cl. 369/270.1; 29/898.07; G9B/23

(57) ABSTRACT

A method for manufacturing a bearing mechanism used in an electric motor includes (a) inserting an annular member into a substantially cylindrical closed-bottom cup member to bring a first end portion of a shaft fitted to the annular member into contact with a thermoplastic resin member arranged on an inner bottom surface of the cup member, bringing the annular member into contact with the shaft in a direction leading from an opening of the cup member to a bottom portion of the cup member, and fixing the annular member to the cup member; and (b) deforming the resin member by externally heating the bottom portion of the cup member and applying a load acting toward the bottom portion on a second end portion of the shaft. Further, an electric motor includes a rotor unit, a stator unit, and the bearing mechanism manufactured by this method.

### FIELD OF THE INVENTION

The present invention relates to a method for manufacturing a bearing mechanism used in an electric motor. The motor is preferably employed in a storage disk drive apparatus.

### BACKGROUND OF THE INVENTION

In a storage disk drive apparatus for driving an optical disk, a magnetic disk or the like, demand for high recording density and high disk rotation speed becomes stronger year by year. In order to meet this demand, a spindle motor as a driving power source needs to show a prolonged lifespan, increased reliability, reduced noise generation, increased vibration accuracy and other properties. For example, a dynamic fluid pressure bearing having a lubricant mainly filled in a radial gap and a thrust gap is often employed in a recently available ramp-loading type storage disk drive apparatus for driving a magnetic disk. In such a storage disk drive apparatus, the radial gap and the thrust gap need to be set smaller in order to avoid a problem of the disk being tilted and making contact a ramp member or other problems. In this regard, if the radial gap is set smaller, the torque loss in the bearing becomes greater, which is undesirable in a mobile application. For that reason, it is important to increase the accuracy of the thrust gap.

If a pivot bearing in which a shaft is brought into contact with and rotatably supported by a thrust member provided on the inner bottom surface of a sleeve housing is employed in a small spindle motor, it is possible to reduce the component cost as compared to using a dynamic fluid pressure bearing in which a shaft is rotatably supported by the dynamic pressure of a lubricant filled in a radial gap and a thrust gap. Just like the dynamic fluid pressure H bearing, however, the pivot bearing requires high accuracy in a gap (an axial gap) that allows the shaft to move in an axial direction. Particularly, when the pivot bearing is used in a ramp-loading type storage disk drive apparatus in which a head unit is supported by a ramp member during stoppage of a disk, a cost-effective bearing assembling method capable of assuring increased accuracy of the axial gap is required in order to prevent contact between the ramp member and the storage disk.

### SUMMARY OF THE INVENTION

In view of the above, there is provided a method for manufacturing a bearing mechanism used in an electric motor, comprising: (a) inserting an annular member into a substantially cylindrical closed-bottom cup member to bring a first end portion of a shaft fitted to the annular member into contact with a thermoplastic resin member arranged on an inner bottom surface of the cup member, bringing the annular member into contact with the shaft in a direction leading from an opening of the cup member to a bottom portion of the cup member, and fixing the annular member to the cup member; and (b) deforming the resin member by externally heating the bottom portion of the cup member and applying a load acting toward the bottom portion on a second end portion of the shaft.

### BRIEF DESCRIPTION OF THE DRAWINGS

FIG. 1 is a vertical section view showing a storage disk drive apparatus in accordance with a first embodiment of the present invention.

FIG. 2 is a vertical section view showing a motor.

FIG. 3 is a vertical section view showing a bearing mechanism.

FIG. 4 is a view illustrating a manufacturing flow of the bearing mechanism.

FIGS. 5 through 9 are views illustrating the bearing mechanism under a manufacturing process.

FIG. 10 is a vertical section view showing a bearing mechanism in accordance with a first modification of the first embodiment.

FIG. 11 is a view illustrating the bearing mechanism under a manufacturing process.

FIG. 12 is a vertical section view showing a bearing mechanism in accordance with a second modification of the first embodiment.

FIGS. 13 through 16 are views illustrating the bearing mechanism under a manufacturing process.

FIG. 17 is a vertical section view showing a bearing mechanism in accordance with a second embodiment.

FIG. 18 is a view illustrating a part of a manufacturing flow of the bearing mechanism.

FIGS. 19 through 22 are views illustrating the bearing mechanism under a manufacturing process.

FIG. 23 is a vertical section view showing a bearing mechanism in accordance with a third embodiment.

FIG. 24 is a view illustrating the bearing mechanism under a manufacturing process.

FIG. 25 is a vertical section view showing a bearing mechanism in accordance with a fourth embodiment.

FIG. 26 is a view illustrating the bearing mechanism under a manufacturing process.

### DETAILED DESCRIPTION OF THE PREFERRED EMBODIMENTS

In the description made herein, the terms “upper”, “lower”, “left” and “right” used in explaining the positional relationship and orientation of individual members are intended to designate - the positional relationship and orientation in the drawings and not to designate the positional relationship and orientation when built in an actual device.

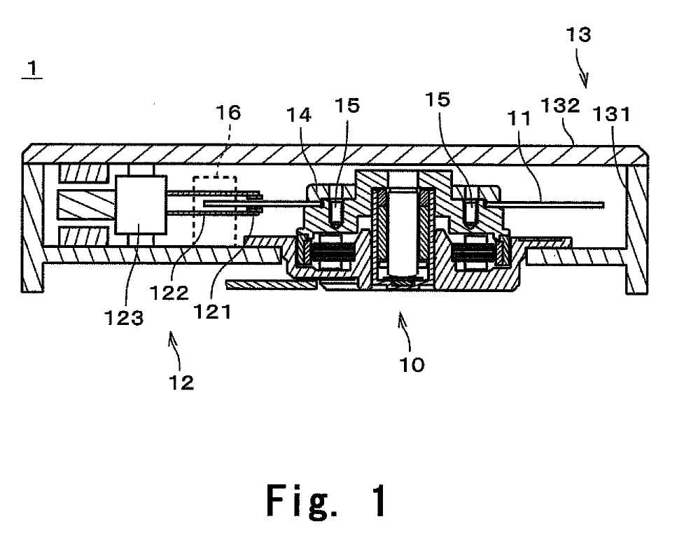

FIG. 1 is a sectional view showing a storage disk drive apparatus 1 provided with an electric spindle motor (hereinafter referred to as a “motor”) in accordance with a first embodiment of the present invention. The storage disk drive apparatus 1 is a so-called hard disk drive. The storage disk drive apparatus 1 includes a storage disk 11 for storing information, an access unit 12 for reading and writing information from and on the storage disk 11, an electric motor 10 for holding and rotating the storage disk 11 and a housing 13 for accommodating the storage disk 11, the motor 10 and the access unit 12 within an internal space thereof. The housing 13 includes a first housing member 131 of cover-free box-like shape having an opening formed in its upper portion, the first housing member 131 having an inner bottom surface on which the motor 10 and the access unit 12 are mounted, and a second housing member 132 of flat shape for covering the opening of the first housing member 131. In the storage disk drive apparatus 1, the second housing member 132 is bonded to the first housing member 131 to form the housing 13. The internal space of the housing 13 is a clean space in which dust is extremely rare.

The storage disk 11 is mounted on the motor 10 and fixed thereto by means of a clamp 14 and a plurality of screws 15. The access unit 12 includes a head 121 for gaining access to the storage disk 11 to magnetically perform reading or writing of information, an arm 122 for supporting the head 121 and a head moving mechanism 123 for moving the arm 122 so that the head 121 can be moved with respect to the storage disk 11 and the motor 10. The head 121 is moved by the head moving mechanism 123 to above the storage disk 11 during rotation of the latter. When the storage disk 11 is stopped, the head 121 is moved to the outside of the storage disk 11 and held on a ramp portion 16 indicated by a broken line in FIG. 1. With this construction, the head 121 gains access to a desired position on the storage disk 11 in a state that it remains adjacent to the storage disk 11 under rotation, thereby performing the tasks of reading and writing information.

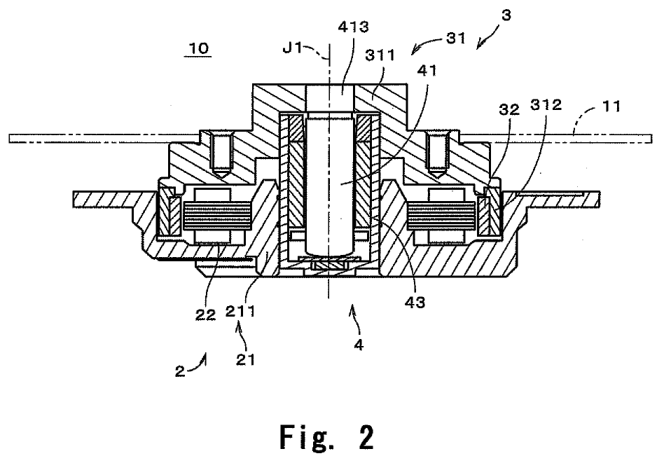

FIG. 2 is a vertical section view of the motor 10, in which view the storage disk 11 is indicated by a double-dotted chain line. The motor 10 is of an outer rotor type and includes a stator unit 2, a rotor unit 3 and a bearing mechanism 4. The rotor unit 3 is mounted to the upper end portion 413 of a shaft 41 of the bearing mechanism 4 and is rotatably supported by the stator unit 2 through the bearing mechanism 4 so that it can rotate relative to the stator unit 2 about the center axis J1 of the motor 10. In the following description, the side on which the rotor unit 3 lies along the center axis J1 will be denoted by the term “upper” and the side on which the stator unit 2 lies along the center axis J1 will be signified by the term “lower”. However, it is not necessary for the center axis J1 to coincide with the direction of gravity.

The rotor unit 3 includes a rotor hub 31, which serves as a main body of the rotor unit 3, and a field magnet 32. The rotor unit 3 is made of a metallic material, e.g., stainless steel. The rotor hub 31 includes a substantially disk-like circular plate portion 311 attached to the upper end portion 413 of the shaft 41, the circular plate portion 311 extending at a right angle with respect to the center axis J1, and a substantially cylindrical yoke 312 protruding downwardly from the outer circumference of the circular plate portion 311. The field magnet 32 is attached to the inner surface of the yoke 312.

The stator unit 2 includes a base bracket 21 having a substantially cylindrical holder 211 formed at the center thereof and a stator 22 attached to around the holder 211. A cylindrical bottom-closed sleeve housing 43 of the bearing mechanism 4 mentioned below is inserted into and fixed to the holder 211. In the present embodiment, the sleeve housing 43 constitutes a cup member. The stator 22 is radially opposed to the field magnet 32. The stator 22 generates a rotational force (torque) acting about the shaft 41 (namely, about the center axis J1) between itself and the field magnet 32.

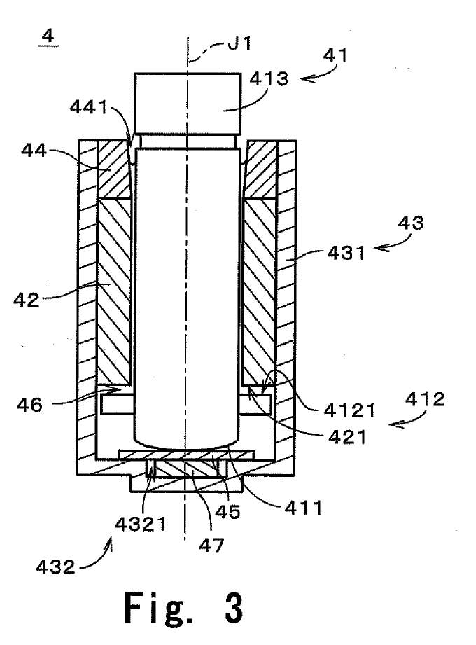

FIG. 3 is a view showing the bearing mechanism 4. As shown in FIG. 3, the bearing mechanism 4 includes a shaft 41, a cylindrical sleeve 42 into which the shaft 41 is inserted, a substantially cylindrical closed-bottom sleeve housing 43 into which the sleeve 42 is inserted, an annular seal member 44 arranged above the sleeve 42 and a thrust member 45 arranged on the inner bottom surface of the sleeve housing 43. In the present embodiment, the sleeve 42 constitutes an annular member. The sleeve 42 is made of a porous material, e.g., sintered metal, and is impregnated with a lubricant. In the present embodiment, the sleeve housing 43 constitutes a cup member. The sleeve housing 43 and the seal member 44 serve to hold the lubricant infiltrated into the sleeve 42.

The shaft 41 is formed into a cylinder shape about the center axis J1. The shaft 41 has an upper end portion 413 protruding upwardly from the sleeve housing 43 and a lower end portion 411 of spherical shape bulged downwardly (toward the thrust member 45). An annular removal-preventing member 412 coaxial with the center axis J1 is attached to the outer circumferential surface of the shaft 41 near the lower end portion 411. In the present embodiment, the removal-preventing member 412 constitutes a plate portion. The sleeve 42 is fixed within the sleeve housing 43. The sleeve 42 has an inner surface radially supporting the shaft 41 through a lubricant. The sleeve 42 has a lower surface 421 opposed to the upper surface 4121 of the removal-preventing member 412 attached to the shaft 41. Between the upper surface 4121 of the removal-preventing member 412 and the lower surface 421 of the sleeve 42, there is formed an axial gap 46 of 10 to 40 μm (exaggeratedly shown in FIG. 3) equivalent to the width within which the shaft 41 is axially movable with respect to the sleeve housing 43. As the shaft 41 is moved upwardly, the upper surface 4121 of the removal-preventing member 412 and the lower surface 421 of the sleeve 42 make contact with each other, thereby preventing the shaft 41 from being removed from the sleeve 42.

The sleeve housing 43 is made of metal and has a cylindrical side portion 431 and a substantially dish-like bottom portion 432. The sleeve housing 43 is formed into a single continuously-extending member by pressing a plate member. The bottom portion 432 has a recess portion 4321 indented downwardly from the inner bottom surface at the center thereof. A resin member 47 to be described later is held within the recess portion 4321. The thrust member 45 has a substantially planar shape and is made of a low friction synthetic resin. The thrust member 45 has a diameter greater than that of the recess portion 4321. The lower surface of the thrust member 45 makes contact with the resin member 47 and the inner bottom surface around the recess portion 4321. The lower end portion 411 of the shaft 41 and the thrust member 45 constitute a pivot bearing that allows the shaft 41 to rotate while making-contact with the thrust member 45 on the center axis J1. An annular tapering gap 441 whose width is gradually increased as it goes away from the sleeve 42 is formed between the shaft 41 and the seal member 44. The lubricant held between the shaft 41 and the sleeve 42 has a boundary surface formed within the tapering gap 441. This prevents the lubricant from being leaked to the outside of the bearing mechanism 4.

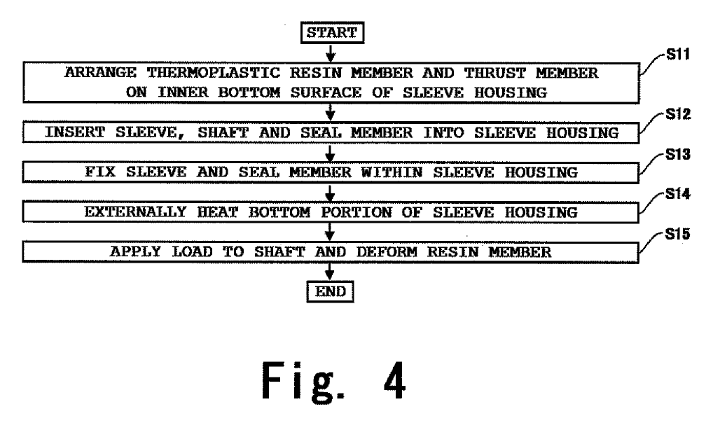

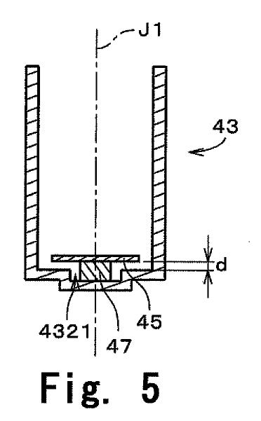

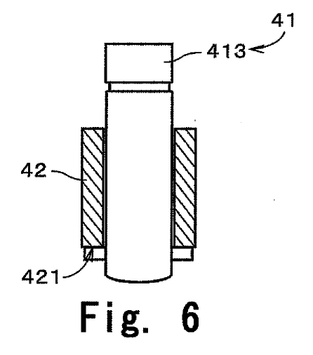

FIG. 4 is a view illustrating a manufacturing flow of the bearing mechanism 4. FIGS. 5 through 9 are views illustrating the bearing mechanism 4 under a manufacturing process. Referring to FIG. 5, the cylindrical resin member 47 made of a thermoplastic resin is first arranged within the recess portion 4321 that forms a portion of the inner bottom surface of the sleeve housing 43. The resin member 47 is fixed to the recess portion 4321 by an adhesive agent. The thrust member 45 having a melting point greater than that of the resin member 47 is fixed to the upper surface of the resin member 47 by an adhesive agent. The dimension along the center axis J1 (i.e., the height) of the resin member 47 is greater than the depth of the recess portion 4321. The difference between the height of the resin member 47 and the depth of the recess portion 4321, i.e., the width d illustrated in FIG. 3, is set equal to the width of the axial gap 46 shown in FIG. 3 (step S11). Referring to FIG. 6, the upper end portion 413 of the shaft 41 is inserted into the sleeve 42 from below. A thermally curable adhesive agent is applied on the outer surfaces of the sleeve 42 and the seal member 44 prepared separately.

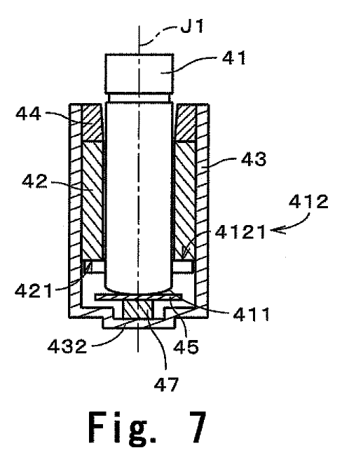

Referring next to FIG. 7, the assembly of the shaft 41 and the sleeve 42 (see FIG. 6) is inserted into the sleeve housing 43 from the lower end portion 411 of the shaft 41 so that the sleeve 42 as an annular member can be fitted to the sleeve housing 43. Furthermore, the seal member 44 is fitted to the sleeve housing 43 so that it can make contact with the upper surface of the sleeve 42. Consequently, the lower end portion 411 of the shaft 41 inserted into the sleeve 42 comes into contact with the upper surface of the resin member 47 through the thrust member 45, at which time the thrust member 45 lies between the lower end portion 411 of the shaft 41 and the resin member 47,

The lower surface 421 of the sleeve 42 makes contact with the upper surface 4121 of the removal-preventing member 412 (that is, the sleeve 42 makes indirect contact with the shaft 41 in a direction leading from the opening of the sleeve housing 43 to the bottom portion 432 thereof). Thus the sleeve 42 is position-determined along the center axis J1 (step S12) Then the sleeve housing 43 is externally heated to cure the adhesive agent existing between the sleeve 42 and the sleeve housing 43 and between the seal member 44 and the sleeve housing 43. By doing so, the sleeve 42 and the seal member 44 are fixed within the sleeve housing 43 (step S13).

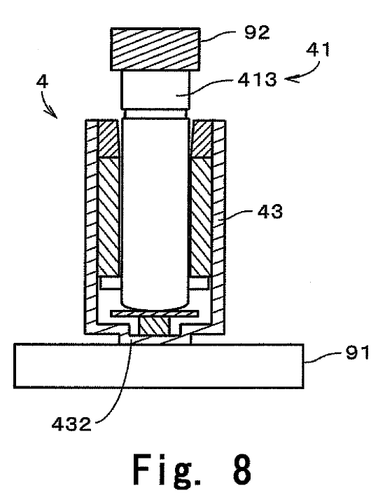

Referring to FIG. 8, the bearing mechanism 4 is then placed on a heater 91 so that the lower surface of the sleeve housing 43 can make contact with the upper surface of the heater 91. A pressing tool 92 is brought into contact with the upper end portion 413 of the shaft 41. In this state, the bottom portion 432 of the sleeve housing 43 is externally heated by the heater 91 (step S14). A downwardly acting load (namely, a load acting toward the bottom portion 432) is applied to the upper end portion 413 of the shaft 41 by the pressing tool 92.

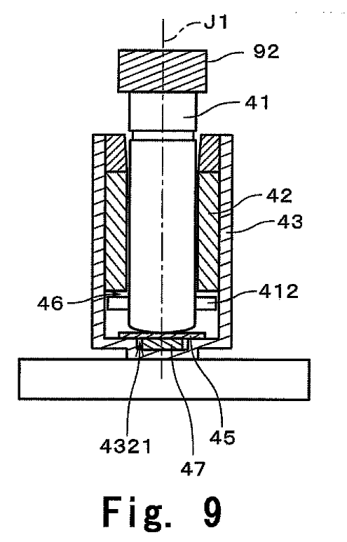

Consequently, as illustrated in FIG. 9, the thermoplastic resin member 47 is softened and plastically deformed by the load received from the pressing tool 92 through the shaft 41 and the thrust member 45, which leads to reduction in the height of the resin member 47 along the center axis J1 (step S15). The pressing operation is performed until the outer edge portion of the lower surface of the thrust member 45 makes contact with the inner bottom surface of the sleeve housing 43 around the recess portion 4321. The resin member 47 thus deformed is held within the recess portion 4321 (namely, within the gap between the thrust member 45 and the inner bottom surface of the sleeve housing 43 defined inwardly of the outer edge portion of the thrust member 45). As a consequence, the positions of the shaft 41 and the thrust member 45 along the center axis J1 are moved downwards, thus creating the axial gap 46 between the sleeve 42 and the removal-preventing member 412.

In the manufacture of the bearing mechanism 4 of the first embodiment as described above, the axial gap 46 that allows the shaft 41 to move along the center axis J1 can be accurately formed by simply deforming the thermoplastic resin member 47. This makes it possible to reduce the manufacturing cost of the bearing mechanism 4. Furthermore, it is possible to employ an assembling method in which the shaft 41, the sleeve 42 and the seal member 44 are placed one above another in one direction while keeping the sleeve housing 43 in place and without having to use any position-determining mechanism. This makes it possible to improve productivity. Since a pressure is applied along the center axis J1 when deforming the resin member 477 it is possible to perform the assembling work with increased accuracy and without causing damage to the inner surface of the sleeve 42 as a radial bearing portion or incurring a change in size. In addition, since the resin member 47 is thermally softened and can be deformed without having to increase the load applied by the pressing tool 92, it is possible to perform the assembling work without causing damage to the thrust member 45 that serves as a thrust bearing portion. Moreover, since the resin member 47 is held within the recess portion 4321, it is possible to prevent, with a simple structure, the resin member 47 from being extruded out of the thrust member 45 during its deformation.

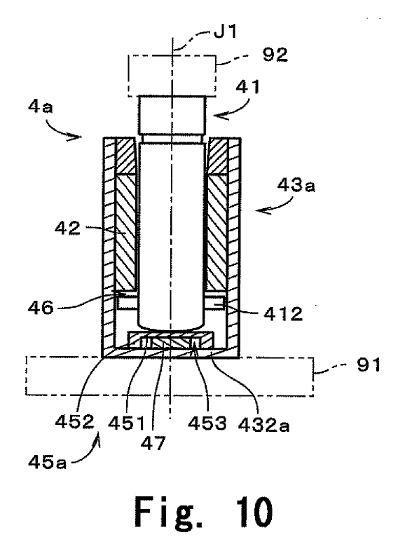

FIG. 10 is a vertical section view showing a bearing mechanism 4a in accordance with a first modification of the first embodiment of the present invention. The bearing mechanism 4a is used in a motor for a storage disk drive apparatus, which is the same as the motor 10 shown in FIG. 2. The bearing mechanism 4a differs in the shape of the sleeve housing and the thrust member from the bearing mechanism 4 shown in FIG. 3. Others remain the same. The bearing mechanism 4a includes a substantially cylindrical closed-bottom sleeve housing 43a and a disk-like bottom portion 432a. The thrust member 45a has a disk-like planar portion 451 and a substantially cylindrical side portion 452 protruding downwardly from the outer circumference of the planar portion 451. A space 453 is defined inwardly of the side portion 452 of the thrust member 45a.

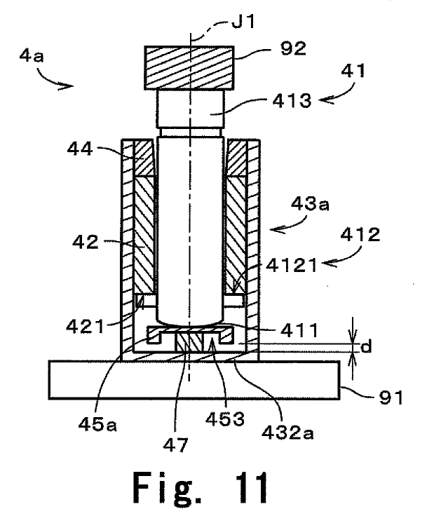

FIG. 11 is a view illustrating the bearing mechanism 4a under a manufacturing process. The manufacturing flow of the bearing mechanism 4a is the same as that of the bearing mechanism 4 illustrated in FIG. 4. First, the resin member 47 is fixed to the inner bottom surface of the sleeve housing 43a by an adhesive agent. The thrust member 45a is bonded to the upper surface of the resin member 47 by an adhesive agent. As shown in FIG. 11, the size of the resin member 47 along the center axis J1 is set greater than the depth of the space 453 by the width d which is equal to the axial gap 46 shown in FIG. 10 (step S11).

Next, the shaft 41 is inserted into the sleeve 42. An adhesive agent is applied on the outer surfaces of the sleeve 42 and the seal member 44. Thereafter, the assembly of the shaft 41 and the sleeve 42 and the seal member 44 are fitted to the sleeve housing 43. At this time, the lower end portion 411 of the shaft 41 makes contact with the upper surface of the thrust member 45a, and the lower surface 421 of the sleeve 42 comes into contact with the upper surface 4121 of the removal-preventing member 412, whereby the sleeve 42 is position-determined along the center axis J1 (step S12). The sleeve 42 and the seal member 44 are fixed within the sleeve housing 43a by externally heating the sleeve housing 43a (step S13).

Referring to FIG. 11, the bearing mechanism 4a is then placed on the heater, and a pressing tool 92 is brought into contact with the upper end portion 413 of the shaft 41. In this state, the bottom portion 432a of the sleeve housing 43a is externally heated by the heater 91 (step S14). A downwardly acting load is applied to the upper end portion 413 of the shaft 41 by the pressing tool 92 (step S15).

As illustrated in FIG. 10, the resin member 47 heated and softened by the heater 91 is plastically deformed by the load received from the pressing tool 92 (indicated by a double-dotted chain line) through the shaft 41 and the thrust member 45a, which leads to reduction in the height of the resin member 47 along the center axis J1. The pressing operation is performed until the lower end of the side portion 452 of the thrust member 45a makes contact with the inner bottom surface of the sleeve housing 43a. As a consequence, the positions of the shaft 41 and the thrust member 45a along the center axis J1 are moved downwards, thus creating the axial gap 46 between the sleeve 42 and the removal-preventing member 412. At this time, the resin member 47 is held within the space 453 defined below the thrust member 45a (namely, within the gap between the thrust member 45a and the inner bottom surface of the sleeve housing 43a formed inwardly of the peripheral edge portion of the thrust member 45a).

In the manufacture of the bearing mechanism 4a according to the first modification of the first embodiment as described above, the axial gap 46 that allows the shaft 41 to move along the center axis J1 can be accurately formed by simply deforming the thermoplastic resin member 47. Moreover, since the resin member 47 is held within the space 453, it is possible to prevent, with a simple structure, the resin member 47 from being extruded out of the thrust member 45a during its deformation.

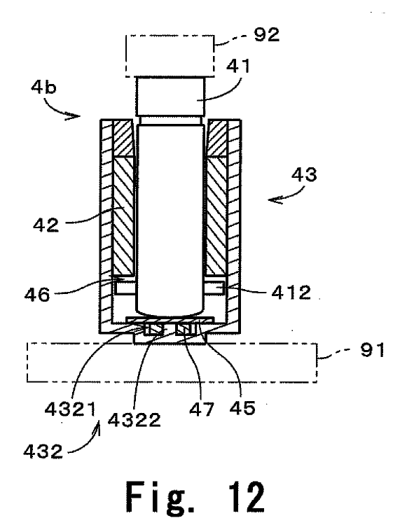

FIG. 12 is a vertical section view showing a bearing mechanism 4b in accordance with a second modification of the first embodiment of the present invention. The bearing mechanism 4b differs in the shape of the bottom portion 432 and the resin member 47 from the bearing mechanism 4 shown in FIG. 3. Others remain the same. As is the case in FIG. 3, the sleeve housing 43 has the recess portion 4321 formed in the bottom portion 432. A protrusion 4322 protruding upwards from the center of the recess portion 4321 is formed within the recess portion 4321. The height of the protrusion 4322 is equal to the depth of the recess portion 4321.

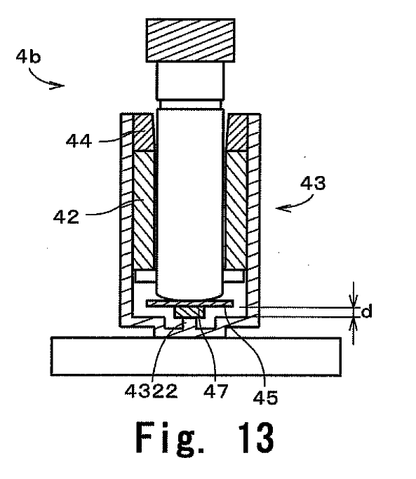

FIG. 13 is a view illustrating the bearing mechanism 4b under a manufacturing process. The manufacturing flow of the bearing mechanism 4b is the same as that of the bearing mechanism 4 illustrated in FIG. 4. Referring to FIG. 13, the resin member 47 is adhesively fixed to between the protrusion 4322 and the thrust member 45 in step S11. The height of the resin member 47 is set equal to the width d which in turn is equal to the axial gap 46 (see FIG. 12). Once the sleeve 42 and the seal member 44 are fixed within the sleeve housing 43 in steps S12 and S13, heating and pressing operations are performed in steps S14 and S15 by the heater 91 and the pressing tool 92 indicated by double-dotted chain lines in FIG. 12. As a result, the resin member 47 is deformed and held within the recess portion 4321 around the protrusion 4322 (namely, within the gap between the thrust member 45 and the inner bottom surface of the sleeve housing 43 formed near the central region of the thrust member 45).

The shaft 41 and the thrust member 45 are moved downwards by a distance equivalent to the original height of the resin member 47, whereby the central region of the thrust member 45 makes contact with the protrusion 4322 that forms a portion of the inner bottom surface of the sleeve housing 43. Thus the axial gap 46 is created between the sleeve 42 and the removal-preventing member 412. When forming the axial gap 46, the protrusion 4322 prevents flexural deformation of the thrust member 45. This makes it unnecessary to control the amount of movement of the shaft 41.

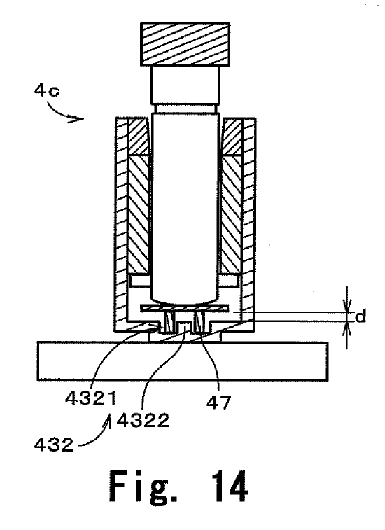

FIG. 14 is a view showing a bearing mechanism 4c in accordance with another example of the second modification of the first embodiment, which is under a manufacturing process. The bearing mechanism 4c shown in FIG. 14 differs only in the shape of the resin member 47 from the bearing mechanism 4b shown in FIG. 13. The resin member 47 of the bearing mechanism 4c has a cylindrical shape when it is not yet deformed. The resin member 47 is arranged on the inner bottom surface of the recess portion 4321 of the bottom portion 432. The height of the resin member 47 is set greater than the depth of the recess portion 4321 by the width d which is equal to the axial gap 46 to be formed (see FIG. 12). Just like the manufacturing flow of the bearing mechanism 4b, the resin member 47 is deformed and held around the protrusion 4322, and the axial gap 46 is created as can be seen in FIG. 12.

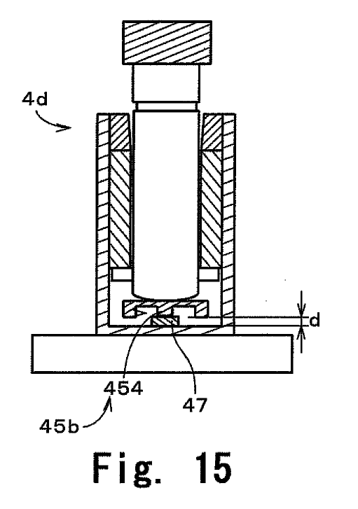

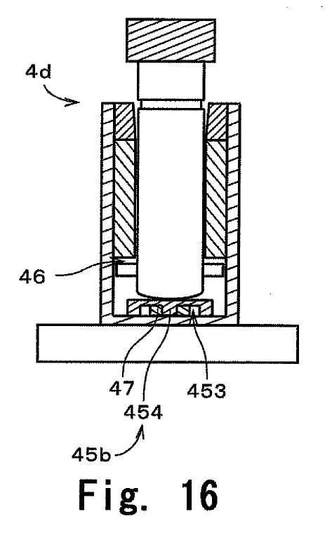

FIGS. 14 and 15 are views showing a bearing mechanism 4d in accordance with a further example of the second modification of the first embodiment, which is under a manufacturing process. The bearing mechanism 4d shown in FIG. 15 differs from the bearing mechanism 4a shown in FIG. 10 in that the former employs a thrust member 45b having a downwardly protruding protrusion 454 formed at the center of the lower surface of the thrust member 45b. Another difference lies in that the height of the resin member 47 is set equal to the width d which in turn is equal to the axial gap 46 to be formed (see FIG. 16). Others remain the same. In other words, the recess portion 4321 and the protrusion 4322 of the sleeve housing 43 shown in FIG. 12 are transferred to the thrust member 45b in the bearing mechanism 4d. In the bearing mechanism 4d, as shown in FIG. 16, the resin member 47 is deformed and held in the space 453 formed around the protrusion 454 below the thrust member 45, thereby creating the axial gap 46. This manufacturing flow is the same as that of the bearing mechanism 4a.

In the methods of manufacturing the bearing mechanisms 4b, 4c and 4d according to the second modification of the first embodiment as described above, the axial gap 46 that allows the shaft 41 to move along the center axis J1 can be accurately formed by simply deforming the thermoplastic resin member 47. Moreover, since the resin member 47 is held within the space 453, it is possible-to prevent, with a simple structure, the resin member 47 from being extruded out of the thrust member 45 or 45b during its deformation. Use of the protrusion 4322 or 454 makes it possible to prevent deformation of the thrust member 45 or 45b which would otherwise be caused by the pressing operation. As in the manufacture of the bearing mechanism 4 of the first embodiment, it is possible to perform the assembling work with increased accuracy and without causing damage to the inner surface of the sleeve 42 as a radial bearing portion or incurring a change in size. In addition, since the resin member 47 is thermally deformed without having to increase the load applied by the pressing tool 92, it is possible to prevent occurrence of damage in the thrust member 45 or 45b that serves as a thrust bearing portion.

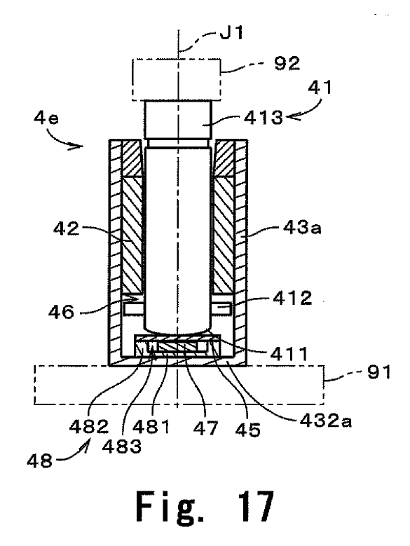

FIG. 17 is a vertical section view showing a bearing mechanism 4e in accordance with a second embodiment of the present invention. The bearing mechanism 4e shown in FIG. 17 differs from the bearing mechanism 4 shown in FIG. 3 in that the former employs a sleeve housing 43a having a planar bottom portion 432a as shown in FIG. 10, instead of the sleeve housing 43. Another difference lies in that the bearing mechanism 4e further includes a support member 48 arranged on the inner bottom surface of the sleeve housing 43a. Others remain the same. In the present embodiment, the sleeve housing 43 and the support member 48 constitute a cup member. The support member 48 has a shallow closed-bottom cylindrical shape and includes a disk-like bottom portion 481 and a side portion 482 protruding upwards from the peripheral edge of the bottom portion 481. The support member 48 is made of metal. The thermoplastic resin member 47 is arranged on the upper surface of the bottom portion 481 and held within a space 483 defined inwardly of the side portion 482. The thrust member 45 is arranged on the side portion 482 and the resin member 47. Just like the bearing mechanism 4 shown in FIG. 3, the thrust member 45 of the bearing mechanism 4e is arranged between the lower end portion 411 of the shaft 41 and the resin member 47. The lower end portion 411 of the shaft 41 and the thrust member 45 constitute a pivot bearing that allows the shaft 41 to rotate while making contact with the thrust member 45 on the center axis J1. In the present embodiment, the sleeve 42 constitutes an annular member.

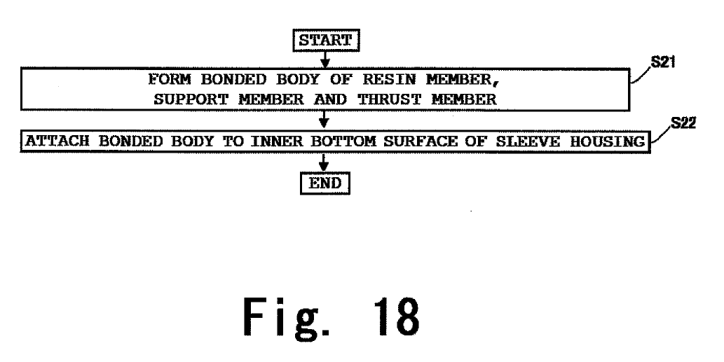

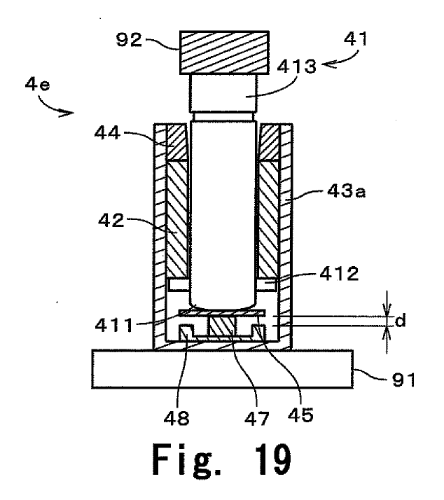

FIG. 18 is a view illustrating a part of a manufacturing flow of the bearing mechanism 4e. FIG. 19 is a view illustrating the bearing mechanism 4e under a manufacturing process. In the manufacturing flow of the bearing mechanism 4e, steps S21 and S22 illustrated in FIG. 18 are performed in place of step S11 shown in FIG. 4. Referring to FIG. 19, a bonded body is first formed by adhesively bonding the lower surface of the resin member 47 to the inner bottom surface of the support member 48 and adhesively bonding the lower surface of the thrust member 45 to the upper surface of the resin member 47 (step S21). The bonded body inclusive of the support member 48, the resin member 47 and the thrust member 45 is adhesively fixed to the inner bottom surface of the sleeve housing 43a so that the lower surface of the support member 48 can make contact with the inner bottom surface of the sleeve housing 43a (step S22). The width d of the gap formed between the upper end portion of the support member 48 and the lower surface of the thrust member 45 in the bonded body is set equal to the width of the axial gap 46 shown in FIG. 17.

A thermally curable adhesive agent is applied on the outer surfaces of the sleeve 42 as an annular member and the seal member 44. The sleeve 42 and the seal member 44 are fitted into the substantially cylindrical closed-bottom sleeve housing 43a as is the case in the first embodiment. At this time, the lower end portion 411 of the shaft 41 inserted into the sleeve 42 comes into contact with the thrust member 45, whereby the lower end portion 411 of the shaft 41 makes indirect contact with resin member 47 through the thrust member 45 (step 812). Thereafter, the sleeve 42 is brought into indirect contact with the shaft 41 through the removal-preventing member 412 in a downward direction (namely, in a direction leading from the opening of the sleeve housing 43a to the bottom portion 432a). The adhesive agent is thermally cured to fix the sleeve 42 and the seal member 44 within the sleeve housing 43a (step S13).

The bearing mechanism 4e is placed on the heater 91, and the pressing tool 92 is brought into contact with the upper end portion 413 of the shaft 41. As indicated by a double-dotted chain line in FIG. 17, the bottom portion 432a of the sleeve housing 43 is externally heated by the heater 91 (step S14). A load acting toward the bottom portion 432a is applied to the upper end portion 413 of the shaft 41 by the pressing tool 92. Consequently, the resin member 47 is plastically deformed, which leads to reduction in the height of the resin member 47 along the center axis J1 (step S15). The pressing operation is performed until the outer edge portion of the lower surface of the thrust member 45 makes contact with the upper end portion of the support member 48. The resin member 47 thus deformed is held within the space 483 (namely, within the gap between the thrust member 45 and the support member 48 defined inwardly of the outer edge portion of the thrust member 45). As the positions of the shaft 41 and the thrust member 45 along the center axis J1 are moved downwards, the axial gap 46 is created between the sleeve 42 and the removal-preventing member 412.

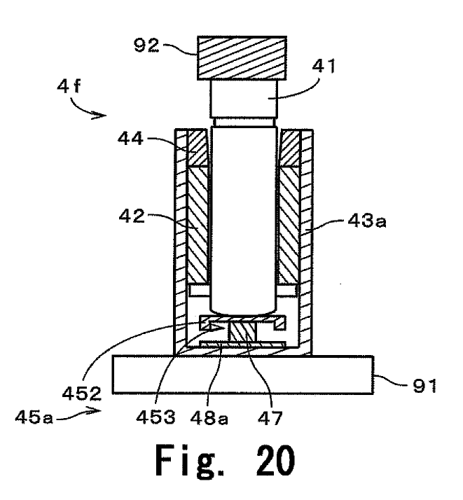

FIG. 20 is a view illustrating a bearing mechanism 4f in accordance with one modification of the second embodiment, which is under a manufacturing process. The bearing mechanism 4f differs from the bearing mechanism 4e shown in FIG. 17 in that the former employs a thrust member 45a having a recess portion formed on the lower side thereof as shown in FIG. 10, instead of the thrust member 45. Another difference lies in that a substantially disk-like support member 48a is employed in place of the support member 48. Others remain the same. In the bearing mechanism 4f, it is Just like the bearing mechanism 4e that a bonded body of the support member 48a, the resin member 47 and the thrust member 45a is formed and arranged on the inner bottom surface of the sleeve housing 43a. Then, the sleeve 42, the shaft 41 and the seal member 44 are inserted into the sleeve housing 43a. The sleeve 42 and the seal member 44 are fixed to the sleeve housing 43a. Thereafter, heating and pressing operations are performed by the heater 91 and the pressing tool 92 to plastically deform the resin member 47. As a consequence, the lower end portion of the side portion 452 of the thrust member 45a comes into contact with the upper surface of the support member 48a. The resin member 47 is held within the space 453 between the support member 48a and the thrust member 45a (namely, within the gap between the thrust member 45a and the support member 48a defined inwardly of the peripheral edge portion of thrust member 45a). This creates the axial gap 46 as shown in FIG. 17.

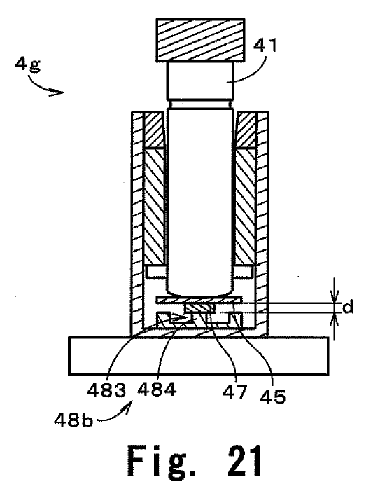

FIG. 21 is a view illustrating a bearing mechanism 4g in accordance with another modification of the second embodiment, which is under a manufacturing process. The bearing mechanism 4g differs from the bearing mechanism 4e shown in FIG. 17 in that the former employs a support member 48b having a protrusion 848 formed at the center of the inner bottom surface thereof, instead of the support member 48. Another difference lies in that the height of the resin member 47 prior to its deformation is set equal to the width d which in turn is equal to the axial gap 46 to be formed (see FIG. 17). Others remain the same. The top end of the protrusion 484 is flush with the peripheral edge portion of the support member 48b. Just like the bearing mechanism 4b shown in FIGS. 12 and 13, the central portion and the peripheral portion of the thrust member 45 make contact with the top ends of the protrusion 484 and the peripheral portion of the support member 48b after the resin member 47 has been plastically deformed. The resin member 47 is held within the space 483 of the support member 48b (namely, within the gap between the thrust member 45 and the support member 48b defined around the central region of the thrust member 45). At this time, the protrusion 484 prevents flexural deformation of the thrust member 45. This makes it possible to accurately form the axial gap without having to control the amount of movement of the shaft 41 during the assembling process.

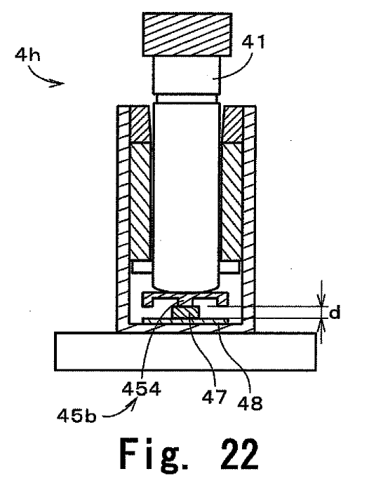

FIG. 22 is a view illustrating a bearing mechanism 4h in accordance with a further modification of the second embodiment, which is under a manufacturing process. The bearing mechanism 4h differs from the bearing mechanism 4f shown in FIG. 20 in that the former employs a thrust member 45b having a protrusion 454 formed on the lower surface thereof as is the case in the bearing mechanism 4d shown in FIGS. 15 and 16, instead of the thrust member 45a. Another difference lies in that the height of the resin member 47 prior to its deformation is set equal to the width d which in turn is equal to the axial gap 46 to be formed. Others remain the same. In the bearing mechanism 4h, the resin member 47 can be held within the gap between the thrust member 45b and the support member 48 defined around the central region of the thrust member 45b. The protrusion 454 prevents flexural deformation of the thrust member 45b which would otherwise occur during deformation of the resin member 47. This makes it possible to accurately form the axial gap without having to control the amount of movement of the shaft 41 during the assembling process.

In the manufacture of the bearing mechanisms 4e to 4h according to the second embodiment as described above, the axial gap 46 that allows the shaft 41 to move along the center axis J1 can be accurately formed by simply deforming the thermoplastic resin member 47. Moreover, use of the support member 48, 48a or 48b makes it possible to easily hold the resin member 47 and the thrust member 45 or 45b within the sleeve housing 43a. It is also possible to prevent, with a simple structure, the resin member 47 from being extruded out of the thrust member 45 or 45b during its deformation. In the bearing mechanisms 4g and 4h, use of the protrusion 484 or 454 makes it possible to prevent deformation of the thrust member 45 or 45b which would otherwise be caused by the pressing operation. As in the manufacture of the bearing mechanism 4 of the first embodiment, it is possible to perform the assembling work with increased accuracy and without causing damage to the inner surface of the sleeve 42 or incurring a change in size. In addition, since the resin member 47 is thermally deformed without having to increase the load applied by the pressing tool 92, it is possible to prevent occurrence of damage in the thrust member 45 or 45b.

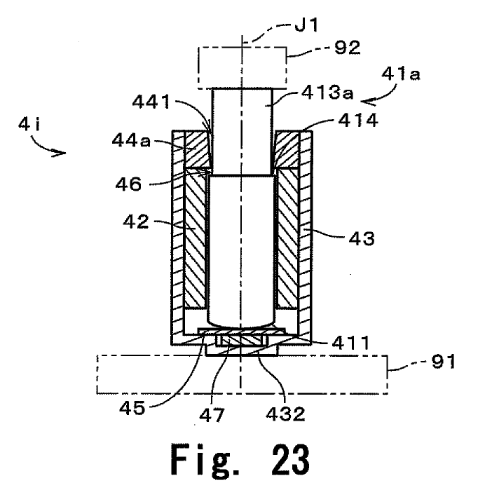

FIG. 23 is a view showing a bearing mechanism 4i in accordance with a third embodiment of the present invention. The bearing mechanism 4i differs from the bearing mechanism 4 shown in FIG. 3 in that the former employs a shaft 41a and a seal member 44a differing in shape from the previously employed ones. The sleeve 42, the sleeve housing 43, the thrust member 45 and the resin member 47 remain the same. In the present embodiment, the sleeve housing 43 constitute a cup member.

The shaft 41a is formed into a cylindrical shape about the center axis J1 and has an upper end portion 413a protruding upwards from the sleeve housing 43. The shaft 41a is further provided with a lower end portion 411 bulged downwards (namely, toward the thrust member 45) to have a spherical surface shape. A step portion 414 whose diameter decreases toward the upper end portion 413a is formed in the boundary between the portion of the shaft 41a extending within the sleeve 42 and the upper end portion 413a. The upper end portion 413a of the shaft 41a has a cylindrical shape with a diameter smaller than that of the portion of the shaft 41a extending downwards from the step portion 414.

The seal member 44a as an annular member is arranged at the side of the opening of the sleeve housing 43 with respect to the sleeve 42. The inner surface of the seal member 44a has a tapering shape with a diameter gradually increasing upwards. The inner diameter of the lower surface of the seal member 44a is smaller than the outer diameter of the portion of the shaft 41a extending downwards from the step portion 414. Between the lower surface of the seal member 44a and the step portion 414 of the shaft 41a, there is formed an axial gap 46 (exaggeratedly shown in FIG. 23) that allows the shaft 41a to move along the center axis J1. With this construction, the step portion 414 makes contact with the lower surface of the seal member 44a as the shaft 41a is moved upwards. This prevents the shaft 41a from being removed from the bearing mechanism 4i. An annular tapering gap 441 whose width becomes greater as it goes away from the sleeve 42 is formed between the shaft 41a and the seal member 44a. A lubricant is held between the shaft 41a and the sleeve 42 so that the boundary surface of the lubricant can be formed within the tapering gap 441. This prevents the lubricant from being leaked out of the bearing mechanism 4i.

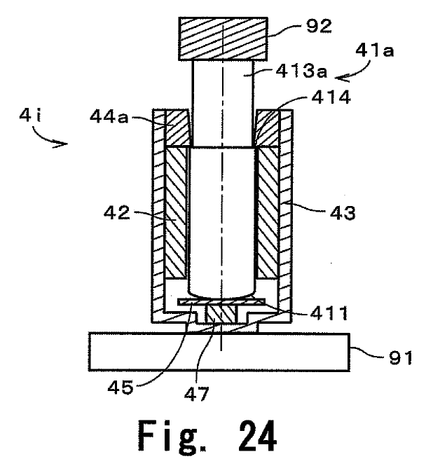

FIG. 24 is a view showing the bearing mechanism 4i under a manufacturing process. The manufacturing flow of the bearing mechanism 4i is substantially the same as that of the bearing mechanism 4 illustrated in FIG. 4. The resin member 47 and the thrust member 45 are first arranged on the inner bottom surface of the sleeve housing 43 (step S11). The sleeve 42, the shaft 41a and the seal member 44a are then inserted into the sleeve housing 43 so that the sleeve 42 and the seal member 44a can be fitted to the sleeve housing 43. The lower end portion 411 of the shaft 41a comes into contact with the upper surface of the thrust member 45 and thus makes contact with the resin member 47 through the thrust member 45 (step S12). At this time, the step portion 414 of the shaft 41a makes contact with the lower surface of the seal member 44a, thereby determining the position of the seal member 44a. Thereafter, the adhesive agent applied in advance on the outer surfaces of the sleeve 42 and the seal member 44a is thermally cured to thereby fix the sleeve 42 and the seal member 44a within the sleeve housing 43 (step S13).

Subsequently, the bearing mechanism 4i is placed on the heater 91, and the pressing tool 92 is brought into contact with the upper end portion 413a of the shaft 41a. As indicated by a double-dotted chain line in FIG. 23, the bottom portion 432 of the sleeve housing 43 is externally heated by the heater 91 (step S14). A load acting toward the bottom portion 432 is applied to the upper end portion 413a of the shaft 41a by the pressing tool 92. Consequently, the resin member 47 is plastically deformed to allow the thrust member 45 and the shaft 41a to move downwards (step S15), thereby creating the axial gap 46. In the bearing mechanism 4i, it may also be possible to suitably use the thrust member 45, 45a or 45b, the resin member 47 and the support member 48, 48a or 48b (and the sleeve housing 43a) that are employed in the bearing mechanisms 4a to 4h.

In the manufacture of the bearing mechanism 4i according to the third embodiment as described above, the axial gap 46 that allows the shaft 41a to move along the center axis J1 can be accurately formed by simply deforming the thermoplastic resin member 47. It is also possible to prevent, with a simple structure, the resin member 47 from being extruded out of the thrust member 45 during its deformation. As in the manufacture of the bearing mechanism 4 according to the first embodiment, it is possible to perform the assembling work with increased accuracy and without causing damage to the inner surface of the sleeve 42 or incurring a change in size. In addition, since the resin member 47 is thermally deformed without having to increase the load applied by the pressing tool 92, it is possible to prevent occurrence of damage in the thrust-member 45.

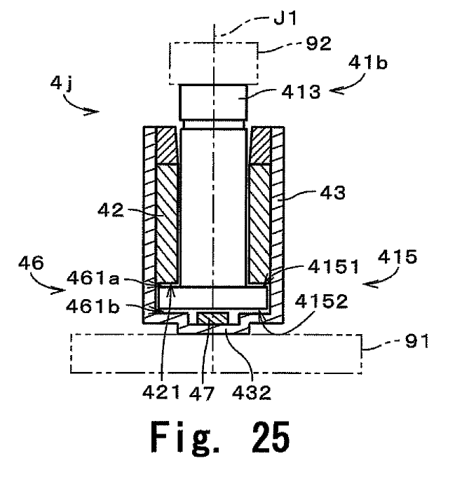

FIG. 25 is a view showing a bearing mechanism 4j in accordance with a fourth embodiment of the present invention. The bearing mechanism 4j differs from the bearing mechanism 4 shown in FIG. 3 in that a shaft 41b having a different shape is employed, with the thrust member 45 omitted. Others remain substantially the same. The upper end portion 413 of the shaft 41b protrudes upwards from the sleeve housing 43. The lower end portion of the shaft 41b is formed of a substantially disk-like thrust dynamic pressure generating portion 415 extending perpendicularly to the center axis J1. In the present embodiment, the thrust dynamic pressure generating portion 415 constitutes a plate portion. Dynamic pressure grooves (e.g., spiral dynamic pressure grooves) are formed on the upper surface 4151 and the lower surface 4152 of the thrust dynamic pressure generating portion 415. Responsive to rotation of the shaft 41b, a dynamic pressure is generated in the lubricant existing between the upper surface 4151 and the lower surface 421 of the sleeve 42 and between the lower surface 4152 and the inner bottom surface of the sleeve housing 43. This creates thrust gaps 461a and 461b between the thrust dynamic pressure generating portion 415 and the sleeve 42 and between the thrust dynamic pressure generating portion 415 and the sleeve housing 43, thereby supporting the shaft 41b in the axial direction. The distance over which the shaft 41b can axially move during stoppage of rotation is equal to the sum total of the axial width of the thrust gaps 461a and 461b. In the present embodiment, the thrust gaps 461a and 461b are collectively referred to as an “axial gap 46”.

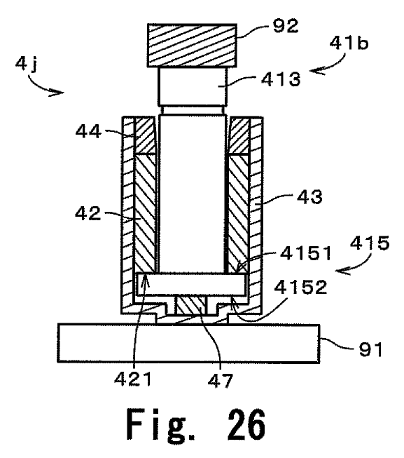

FIG. 26 is a view illustrating the bearing mechanism 4j under a manufacturing process. The manufacturing flow of the bearing mechanism 4j is substantially the same as that of the bearing mechanism 4 shown in FIG. 4. The resin member 47 is first arranged within the sleeve housing 43 (step S11). The shaft 41b, the sleeve 42 and the seal member 44 are then inserted into the sleeve housing 43 so that the lower surface 4152 of the thrust dynamic pressure generating portion 415, i.e., the lower end portion of the shaft 41b, can make direct contact with the resin member 47 (step S12). At this time, the upper surface 4151 of the thrust dynamic pressure generating portion 415 of the shaft 41b comes into contact with the lower surface 421 of the sleeve 42. The seal member 44 makes contact with the upper surface of the sleeve 42. Thus the positions of the sleeve 42 and the seal member 44 are determined. Thereafter, the adhesive agent applied in advance on the outer surfaces of the sleeve 42 and the seal member 44 is thermally cured to thereby fix the sleeve 42 and the seal member 44 within the sleeve housing 43 (step S13).

Subsequently, the bearing mechanism 4j is placed on the heater 91, and the pressing tool 92 is brought into contact with the upper end portion 413 of the shaft 41b. As indicated by a double-dotted chain line in FIG. 25, the bottom portion 432 of the sleeve housing 43 is externally heated by the heater 91 (step S14). A load acting toward the bottom portion 432 is applied to the upper end portion 413 of the shaft 41b by the pressing tool 92. Consequently, the resin member 47 is plastically deformed to allow the shaft 41b to move downwards (step S15), thereby creating the axial gap 46.

In the manufacture of the bearing mechanism 4j according to the fourth embodiment as described above, the axial gap 46 that allows the shaft 41a to move along the center axis J1 can be accurately formed by simply deforming the thermoplastic resin member 47. As in the manufacture of the bearing mechanism 4 according to the first embodiment, it is possible to perform the assembling work with increased accuracy and without causing damage to the inner surface of the sleeve 42 or incurring a change in size.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

For example, the material of which the thrust member 45, 45a or 45b is made in the bearing mechanism having the pivot bearing shown in FIGS. 3 and 17 is not limited to the low friction resin but may be other materials. The central region of the upper surface of the thrust member 45 may be not only a planar surface but also a concave spherical surface having a radius of curvature greater than that of the lower end portion 411 of the shaft 41 or 41a. The central region of the upper surface of the thrust member 45 may be an upwardly-bulging spherical surface, in which case the lower end portion (the tip end of the lower end portion) of the shaft 41 or 41a may be formed into a planar shape. In other words, one of the lower end portion 411 of the shaft 41 and the thrust member 45 may have a convex surface, and the other may have a concave or planar surface.

If at least the protrusion 4322 of the sleeve housing 43 shown in FIG. 12 is made of a low friction resin, the thrust member 45 may be omitted and the tip end of the shaft 41 may make direct contact with the upper end portion of the protrusion 4322 to provide a pivot bearing. In case the sleeve housing 43 is made of a resin, it is preferred that the resin has a melting point higher than that of the resin member 47.

The shape of the thermoplastic resin member 47 is not limited to the cylindrical column shape shown in Fig. S or the hollow cylinder shape illustrated in FIG. 14 but may be a polygonal column shape or other shapes. A plurality of resin members may be arranged along the circumferential direction. The resin member 47 shown in FIGS. 5, 11 and 13 may be fixed to the sleeve housing 43 or 43a by a fixing means other than the adhesive agent. The resin member 47 and the sleeve housing 43 may be integrally formed with each other in advance by outsert molding. In case the sleeve housing 43 is made of a resin, the sleeve housing 43 may be integrally formed with the resin member 47 by two-color molding.

The annular member that determines the axial gap 46 between itself and the removal-preventing member 412 or the shaft 41a is not limited to the sleeve 42 or the seal member 44 but may be other members fitted to the sleeve housing 43 or 43a. The removal-preventing member 412 may be either integrally formed with the shaft 41 or formed independently of the shaft 41. The support member 48, 48a or 48b shown in FIGS. 19 and 20 and the resin member 47 may be bonded together by a fixing means other than the adhesive agent. The support member 48 and the resin member 47 may be integrally formed with each other by subjecting the resin member 47 to outsert molding. The support member 48 may be made of a material other than metal, e.g., a ceramic material or a thermosetting resin. The support member 48 and the resin member 47 may differ in melting point from each other and may be integrally formed by two-color molding.

The task of assembling the bearing mechanism 4 of the first embodiment is not limited to, e.g., the sequence employed in step S12 in which the shaft 41 is inserted into the sleeve 42 and then the sleeve 42 is fitted to the sleeve housing 43. As an alternative example, the shaft 41 may be first inserted into the sleeve housing 43 and then the sleeve 42 may be fitted to the sleeve housing 43. The assembling method of the bearing mechanism 4 may be arbitrarily changed within a permissible extent. This holds true in assembling the bearing mechanisms of other embodiments.

The dynamic pressure grooves of the thrust dynamic pressure generating portion 415 of the bearing mechanism 4j shown in FIG. 25 may be formed on the lower surface 421 of the sleeve 42 or on the inner bottom surface of the sleeve housing 43. The sleeve housing 43a shown in FIG. 10 may be employed in place of the sleeve housing 43, and the space (i.e., the recess portion) for holding the resin member 47 in place may be formed in the bottom portion of the thrust dynamic pressure generating portion 415.

In the foregoing embodiments, the axial gap 46 can be formed after the shaft, the sleeve, the seal member and the like are inserted into the sleeve housing. Therefore, the present invention is particularly suitable for assembling a bearing mechanism in which a substantially cylindrical closed-bottom sleeve housing is formed of a single continuous member. However, the sleeve housing may be constructed from a plurality of components.

The storage disk drive apparatus 1 is not limited to the hard disk drive but may be an apparatus for driving an optical disk, a magneto-optical disk or other disks. The bearing mechanism is suitable for use in a storage disk drive apparatus that performs one of the tasks of reading and writing information with respect to a storage disk, i.e., a reading task or a writing task. Furthermore, the bearing mechanism may be used in motors of other devices such as a laser printer and the like.

What is claimed is:

1. A method for manufacturing a bearing mechanism used in an electric motor, comprising:
(a) inserting an annular member into a substantially cylindrical closed-bottom cup member to bring a first end portion of a shaft fitted to the annular member into contact with a thermoplastic resin member arranged on an inner bottom surface of the cup member, bringing the annular member into contact with the shaft in a direction leading from an opening of the cup member to a bottom portion of the cup member, and fixing the annular member to the cup member; and
(b) deforming the resin member by externally heating the bottom portion of the cup member and applying a load acting toward the bottom portion on a second end portion of the shaft.

2. The method of claim 1, wherein a radially extending plate portion is provided in the first end portion of the shaft and wherein, in the step (a), the annular member is brought into contact with the shaft through the plate portion.

3. The method of claim 1, wherein a thrust member is positioned between the first end of the shaft and the resin member and wherein, in the step (b), a pivot bearing that allows the shaft to rotate while making contact with the thrust member on a center axis is constructed from the first end portion of the shaft and the thrust member.

4. The method of claim 3, wherein, in the step (b), a peripheral edge portion of the thrust member is allowed to make contact with the inner bottom surface of the sleeve housing, the resin member being held within a gap between the thrust member and the inner bottom surface, the gap being defined inwardly of the peripheral edge portion of the thrust member.

5. The method of claim 3, wherein, in the step (b), a central portion of the thrust member is allowed to make contact with the inner bottom surface of the sleeve housing, the resin member being held within a gap between the thrust member and the inner bottom surface, the gap being defined around the central portion of the thrust member.

6. The method of claim 1, wherein the cup member comprises a substantially cylindrical closed-bottom sleeve housing formed into a single continuous member.

7. The method of claim 1, wherein a seal member is further provided within the cup member and wherein, in the step (a), the annular member has a first end surface making contact with the shaft and a second end surface making contact with the seal member.

8. The method of claim 1, wherein the annular member comprises a seal member having a first end surface making contact with the shaft in the step (a).

9. The method of claim 1, wherein the cup member comprises a substantially cylindrical closed-bottom sleeve housing and a support member, the resin member being installed on the inner bottom surface of the cup member through the support member.

10. The method of claim 9, further comprising:
forming a bonded body by bonding the support member and the resin member together and bonding the resin member and the thrust member together; and
installing the support member of the bonded body on the inner bottom surface of the sleeve housing,
wherein the bonded body forming step and the support member installing step are performed prior to the step (a).

11. An electric motor comprising:
the bearing mechanism manufactured by the method of claim 1;
a rotor unit attached to the second end of the shaft, the rotor unit having a field magnet; and
a stator unit to which the bearing mechanism is fixed, the stator unit having a stator opposed to the field magnet.

12. A storage disk drive apparatus comprising:
the electric motor of claim 11 for rotating a storage disk;
an access unit for reading or writing information from or on the disk; and
a housing for accommodating the electric motor and the access unit.
